(19) United States
(12) Patent Application Publication
(10) Pub. No.: US 2014/0263830 A1
(43) Pub. Date: Sep. 18, 2014

(54) LAUNCH LIGHTNING RISK MITIGATION SYSTEM AND METHOD

(71) Applicant: Alliant Techsystems Inc., Arlington, VA (US)

(72) Inventor: John S. Canham, Ellicott City, MD (US)

(73) Assignee: Alliant Techsystems Inc., Arlington, VA (US)

(21) Appl. No.: 13/844,105

(22) Filed: Mar. 15, 2013

(51) Int. Cl. B64D 45/02

(52) U.S. Cl. CPC B64D 45/02
USPC 244/1 A

(57) ABSTRACT

A system and method for launching a launch vehicle in the presence of lightning. A processor detects potential sources of lightning and maneuvers one or more charge mitigation vehicles to locations proximate to the potential source of lightning such that at least one charge mitigation vehicle remains a better path to ground than the launch vehicle being launched at any given time during the launch.

### BACKGROUND

The presence of lightning and/or storms in the vicinity of a launch pad typically results in launch delays. These delays can run from minutes to months. These delays cost large amounts of money due to costs of maintaining personnel on standby, and due to the cost of rework necessary due to an aborted launch attempt. In most cases, the risk to the space craft on the launch pad is minimal due to grounding and charge abatement processes on the launch support structures. A much bigger risk is the risk of lightning striking the launch vehicle during launch.

What is needed is a system and method for reducing the likelihood of a lightning strike during the launch process.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a launch system with reduced lightning risk;

FIG. 2 illustrates a method of reducing lightning risk during launch of a launch vehicle;

FIG. 3 illustrates another method of reducing lightning risk during launch of a launch vehicle; and

FIGS. 4A and 4B illustrate operation of a launch system such as shown in FIG. 1; and

FIGS. 5-8 illustrate other example launch systems with reduced lightning risk.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

A launch system 100 is shown in FIG. 1. As shown in in FIG. 1, system 100 includes a launch vehicle 102 and a launch lightning risk mitigation system 103. In one example embodiment, launch lightning risk mitigation system 103 includes a weather monitor 104, a controller 106 and one or more charge mitigation vehicles 108.1-108.N. Each charge mitigation vehicle 108 includes a conductor.

In launch lightning risk mitigation system 103 of FIG. 1, controller 106 is connected to weather monitor 104 and to the plurality of charge mitigation vehicles 108. In one such embodiment, controller 106 operates with the weather monitor to identify potential sources of lightning. Controller 106 also determines if the launch vehicle 102 is at risk of lightning and maneuvers one or more charge mitigation vehicles 108 proximate to the potential sources of lightning to provide reduced resistance paths through their conductors to ground. In one example embodiment, the controller 106 monitors the potential lightning sources during launch of the launch vehicle 102 and moves the charge mitigation vehicles as needed to reduce risk of lightning strikes on the launch vehicle during launch of the launch vehicle.

One example embodiment of launch system 100 is shown in FIG. 2. In the embodiment shown in FIG. 2, a launch vehicle 102 is surrounded by charge mitigation vehicles 108. In this example, the charge mitigation vehicles 108 include lightning rockets, which are, in one example embodiment, sounding rockets that drag a conductor into a highly charged region in order to reduce the charge. The conductor provides a conductive path 110 to ground.

In another embodiment, each rocket includes fuel that has been modified to create a conductive exhaust trail as the rocket flies to the highly charged region. The conductive exhaust trail serves as the conductive path 110. Such a rocket was described by Betts in U.S. Pat. No. 6,597,559, the description of which is incorporated herein by reference.

An example method for lightning risk mitigation is shown in FIG. 2. At 200, highly charged regions of the atmosphere close to the launch vehicle are detected. The launch vehicle is launched at 202 and charge mitigation vehicles 108 are placed proximate to the highly charged regions to drain charge from the highly charged region.

Another example method for lightning risk reduction is shown in FIG. 3. In the example shown in FIG. 3, highly charged regions of the atmosphere close to the projected path of the launch vehicle are detected at 300 and, at 302, interaction between the highly charged regions and the launch vehicle are studied through a simulation. Locations proximate to the charged regions that are along the path of the launch vehicle are selected at 304 and the launch vehicle is launched at 306. The charge mitigation vehicles 108 are launched at 308 in a window around the launch and are used to drain charge from the highly charged regions.

In both the example shown in FIG. 2 and that shown in FIG. 3, within a short time of the nominal launch time of a launch vehicle 102, a number of lightning rockets 108 are launched, with the grounding wires attached. In one example embodiment, rockets 108 are launched in a circle of 1-10 kilometers surrounding the spacecraft launch vehicle, to decrease the charge surrounding the launch vehicle. In one such embodiment, the rockets used are primarily small sounding rockets with deployable grounding wires, as used in lightning research. Such rockets, when launched, initiate lightning following the straight grounding wire path, thus depleting the atmospheric charge.

An example launch system 100 is shown in FIGS. 4A and 4B. In the example shown in FIG. 4, charge mitigation vehicles 108 are launched prior to launch of launch vehicle 102 to deplete highly charged region 112. In the embodiment shown in FIGS. 4A and 4B, each charge mitigation vehicle 108 creates a conductive path 110 from the charged regions 112 to ground. In one embodiment, conductive path 110 is a grounding wire deployed as the vehicle 108 flies up into region 112. In another embodiment, the conductive path 110 is the exhaust trail left by each vehicle 108.

As can be seen in FIG. 4B, if it is determined that the charge in the region 112 of FIG. 4A was not sufficiently depleted, more charge mitigation vehicles 108 are launched just prior to the launch of launch vehicle 102. They also deploy a conductive path 110 from region 112 to ground.

Another embodiment of charge mitigation vehicle is shown in FIG. 5. In the example embodiment shown in FIG. 5, each charge mitigation vehicle 118 is a balloon 120 with a conductive tether 122. In one example embodiment, balloon 120 is a weather balloon. In the embodiment shown in FIG. 5, each charge mitigation vehicle 118 creates a conductive path 122 from the charged regions 112 to ground. In another example embodiment, each balloon 120 is untethered; a grounding wire is instead deployed as the balloon rises through the charged region 112. That grounding wire creates a conductive path 122 from the charged regions 112 to ground. Once again, the launch of the balloons 120 can be staggered as shown in FIGS. 4A and 4B.

Yet another example embodiment of a launch system 100 is shown in FIG. 6. In the example shown in FIG. 6, charge mitigation vehicles 130 are dropped through a highly charged region 112 in order to deplete the charge in the highly charged region 112. In the example embodiment shown in FIG. 6, each charge mitigation vehicle 130 includes a drag member 134, a conductor 136 and a pendant member 132. The drag member 134 functions to slow an upper portion of vehicle 130 to maintain the upper portion of the vehicle 130 in the highly charged atmosphere 112 of an electrical storm. The drag member 134 of the embodiment of FIG. 6 is a drag chute. In one example embodiment, conductor 136 is coupled to the drag member 134 as illustrated in FIG. 6. In one embodiment, conductor 136 is ungrounded wire. In one such embodiment, the conductor has a length of approximately between 500 to 1000 meters. Air breaks down as an insulator at approximately 25 kV/cm. In use, as the pendant 132 gets close to the ground 138, a voltage potential difference of approximately a million volts between the pendant 132 and ground 138 is created that will result in the generation of a lighting strike 150. In one embodiment, the proximity of the pendant 132 to the ground 138 and the potential difference between the two will result in the vaporization and ionization of the conductor 136 and the establishment of an initial lightning strike 150. The initial lighting strike will be followed by typically a significantly larger second lightning strike 150. Hence, in embodiments, the pendant 132 does not have to reach the ground 138 for a lightning strike 150 to occur as illustrated in FIG. 6. The term ground 138 is generally used to refer to solid earth as well as bodies of water.

In the embodiment of FIG. 6, the pendant member 132 is merely an unguided mass. The pendant mass is of sufficient weight and shape that it accelerates towards the ground 138. In one example embodiment, the difference between the rate of acceleration of the pendant mass 132 and the drag member 134 causes the conductor 136 to extend out between the pendant mass 132 and the drag member 134. The charge mitigation vehicles 130 are positioned by either dropping them from an aircraft or delivering them with the use of a rocket or the like launched from the ground into the highly charged atmosphere 112.

In one embodiment, the devices 130 are positioned above the highly charged atmosphere by an aerial platform (such as an airplane, helicopter or UAV) or by a rocket and then allowed to fall down into the highly charged atmosphere 112. In this unguided mass embodiment, the pendant member 132 is directed to a desired location based on its initial placement and its falling characteristics. Hence, to achieve a desired placement of a lightning direction device 130 of this embodiment, the falling characteristics of the device 130 must first be known. The falling characteristics include how fast the device 130 will fall and what is the drag coefficient of the drag member 134. Once the falling characteristics are determined, an initial location placement position can be determined to achieve a desired positioning outcome. Although the accuracy may have it limits, this embodiment has advantages. For instance, the devices 130 are relatively inexpensive to make. Hence, a plurality of devices 130 can be dropped from an aerial platform or rocket for very little money. In addition, in an application where it is desirable to deplete the charge in the atmosphere, a large number of lightning directing devices 130 could be used.

In some example embodiments, pendant members 132 are steerable in flight. In some such embodiments, as is shown in FIG. 7, pendant members 132 include a control surface, such as fins 208, that are deployed to steer the charge mitigation vehicle 130 to a location proximate the charged region 112. In the example embodiment shown in FIG. 7, drag member 134 is a parachute. In one such embodiment, a global positioning system (GPS) 212 is used to provide directions and a controller 214 is used to control fins 208-1 through 208-N based on a signal from the GPS 212. In some embodiments, controller 214 communicates in flight with controller 106 and can change direction under control of controller 106 to move to a different are of charged region 112.

In some such embodiments, the pendant mass and drag members are selected such that vehicle 130 achieves sufficient velocity when falling that the control surfaces 208-1 through 208-N have sufficient effect to direct the vehicle 130. In an example embodiment, a precision guidance kit (PKG) is attached to pendant member 132 to provide guidance. Other type of guidance systems beside the GPS 212 are contemplated, including inertial guidance systems 212 and the like.

In another embodiment, as is shown in FIG. 8, pendant members 132 include propulsion units that are deployed to steer the charge mitigation vehicle 130 to a location proximate the charged region 112. In the example embodiment shown in FIG. 8, a charge mitigation vehicle 130 includes a drag member 134, a conductor 136 and a pendant mass 132. The device 130 is illustrated as falling from a highly charged atmosphere 112 to the ground 138. The drag member 134 in this embodiment is a parachute 304. The pendant member 132 in this embodiment is propulsion driven. In particular, this embodiment of the pendant 132 includes propulsion units 308-1 through 308-N that are used to direct the device 130 to a desired location. The pendant member 132 includes a guidance system 310 and a controller 312. The controller 312 controls propulsion units 308-1 through 308-N based on signals from the guidance system 310.

Other types of engines or devices could be used maneuver pendant members 132 in the air. Similarly, control surfaces or propulsion units could be used with the balloons 120 of FIG. 5 to maneuver vehicles 118.

The present invention is not limited to the examples proved above. In one embodiment, plasma contactors 314 are used as illustrated in the embodiment of FIG. 8 to provide better coupling between the drag member 304 and the pendant 302. In this embodiment the coupling of more energy into the initiated discharge is achieved by equalizing the local charge of the environment. The effect of using plasma contactors 314 is similar to creating a larger chargeable surface at the top of the charge mitigation vehicle 130.

The systems and methods described above reduce the probability of lightning striking a launch vehicle during launch. This reduces the chance of damage to the launch vehicle, and opens up opportunities to launch that have heretofore been restricted by the potential for lightning damage. The above described systems and methods therefore have the potential to save lives and money in the launch process.

The above described systems and methods can be used in other situations where one wants to reduce the danger due to lightning. It could be used around airports, or at outdoor public events such as golf tournaments, football games and the like.

Although specific embodiments have been illustrated and described herein, it will be appreciated by those of ordinary skill in the art that any arrangement which is calculated to achieve the same purpose may be substituted for the specific embodiments shown. The invention may be implemented in various modules and in hardware, software, and various combinations thereof, and any combination of the features described in the examples presented herein is explicitly contemplated as an additional example embodiment. This application is intended to cover any adaptations or variations of the example embodiments of the invention described herein. It is intended that this invention be limited only by the claims, and the full scope of equivalents thereof.

What is claimed is:

1. A launch lightning risk mitigation method, comprising:
detecting potential sources of lightning;
launching a launch vehicle; and
maneuvering one or more charge mitigation vehicles to a location proximate to the potential source of lightning such that at least one charge mitigation vehicle remains a better path to ground than the launch vehicle at any given time during the launch.

2. The method of claim 1, wherein maneuvering includes launching the one or more charge mitigation vehicles from a location on the ground.

3. The method of claim 1, wherein maneuvering includes dropping the one or more charge mitigation vehicles from the air.

4. The method of claim 1, wherein maneuvering includes monitoring potential sources of lightning and moving the charge mitigation vehicles to address the potential sources of lightning.

5. A launch lightning risk mitigation system, comprising:
a weather monitor;
one or more charge mitigation vehicles, wherein each charge mitigation vehicle includes a conductor; and
a controller connected to the weather monitor and to the plurality of charge mitigation vehicles, wherein the controller operates with the weather monitor to identify potential sources of lightning, to determine if a launch vehicle is at risk of lightning and to maneuver one or more charge mitigation vehicles proximate to the potential sources of lightning, wherein the charge mitigation vehicles provide reduced resistance paths through their conductors to ground;
wherein the controller monitors the potential lightning sources during launch of a launch vehicle and moves the charge mitigation vehicles as needed to reduce risk of lightning strikes on the launch vehicle during launch of the launch vehicle.

6. The system according to claim 5, wherein the charge mitigation vehicles include rockets.

7. The system according to claim 6, wherein the rockets include deployable grounding wires and wherein the deployable grounding wires serve as a conductive path to ground for charge from one or more of the potential sources of lightning.

8. The system according to claim 6, wherein the rockets include fuel that has been formulated to leave a conductive exhaust trail when the rocket is launched, wherein the conductive exhaust trail serves as a conductive path to ground for charge from one or more of the potential sources of lightning.

9. The system according to claim 5, wherein the charge mitigation vehicles include balloons.

10. The system according to claim 5, wherein each charge mitigation vehicle includes a drag member and a pendent connected to a conductor.

11. The system according to claim 10, wherein the pendant includes control surfaces.

12. The system according to claim 10, wherein the pendant includes one or more propulsion units.

13. The system according to claim 10, wherein the charge mitigation vehicle includes one or more plasma contractors.

14. A launch lightning risk mitigation method, comprising:
detecting potential sources of lightning;
performing a simulation of interaction between a launch vehicle and the potential sources of lightning;
launching the launch vehicle;
selecting, based on the simulation, locations proximate to the potential sources of lightning to place one or more charge mitigation vehicles; and
maneuvering the charge mitigation vehicles to the locations proximate to the potential sources of lightning such that the charge mitigation vehicles reduce the risk the launch vehicle is struck by lightning.

15. The method according to claim 14, wherein maneuvering includes activating control surfaces on the charge mitigation vehicle.

16. The method according to claim 14, wherein maneuvering includes activating control surfaces on a rocket.

17. The method according to claim 14, wherein maneuvering includes activating one or more propulsion units on the charge mitigation vehicle.

18. A launch system, comprising:
a launch vehicle;
a weather monitor;
one or more charge mitigation vehicles, wherein each charge mitigation vehicle includes a conductor; and
a controller connected to the weather monitor and to the plurality of charge mitigation vehicles, wherein the controller operates with the weather monitor to identify potential sources of lightning, to determine if the launch vehicle is at risk of lightning and to maneuver one or more charge mitigation vehicles proximate to the potential sources of lightning to provide reduced resistance paths through their conductors to ground;
wherein the controller monitors the potential lightning sources during launch of the launch vehicle and moves the charge mitigation vehicles as needed to reduce risk of lightning strikes on the launch vehicle during launch of the launch vehicle.

19. The system according to claim 18, wherein one of the charge mitigation vehicles includes a controller and one or more control surfaces, wherein the controller controls the one or more control surfaces, and wherein the controller communicates with the controller on the charge mitigation vehicle to move the charge mitigation vehicle as needed.

20. The system according to claim 18, wherein the controller activates control surfaces on a rocket.

21. The system according to claim 18, wherein the controller activates one or more propulsion units on the charge mitigation vehicle.

22. The system according to claim 18, wherein the charge mitigation vehicle includes one or more plasma contractors.

23. A tangible computer readable medium comprising a plurality of instructions that, in response to being executed on a computing device, cause the computing device to:
detect potential sources of lightning;
launch a launch vehicle; and
maneuver one or more charge mitigation vehicles to a location proximate to the potential source of lightning such that at least one charge mitigation vehicle remains a better path to ground than the launch vehicle at any given time during the launch.

24. The medium according to claim 23, wherein the plurality of instructions include instructions that, in response to being executed on a computing device, cause the computing device to:
perform a simulation of interaction between a launch vehicle and the potential sources of lightning; and
select, based on the simulation, locations proximate to the potential sources of lightning to place one or more charge mitigation vehicles.
